(19) United States
(12) Patent Application Publication
(10) Pub. No.: US 2013/0159781 A1
(43) Pub. Date: Jun. 20, 2013

(54) System For Compression Of Fixed Width Values In A Processor Hardware Trace

(71) Applicant: James Hippisley Robinson, New York, NY (US)

(72) Inventor: James Hippisley Robinson, New York, NY (US)

(73) Assignee: MIPS TECHNOLOGIES, INC., Sunnyvale, CA (US)

(21) Appl. No.: 13/328,781

(22) Filed: Dec. 16, 2011

(51) Int. Cl. G06F 11/34

(52) U.S. Cl. 714/45; 714/E11.189

(57) ABSTRACT

A method of tracing processor instructions includes forming a compressed trace stream with a dynamic unit width indicator and a value block. The dynamic unit width indicator includes an address/data width indicator qualified by a unit indicator. The unit value block has a width that is a function of the address/data width indicator and the unit indicator.

### BRIEF DESCRIPTION OF THE INVENTION

This invention relates generally to digital data processors. More particularly, this invention relates to a technique for compression of fixed width values in a processor hardware trace.

### BACKGROUND OF THE INVENTION

There are many known techniques for tracing information from a digital data processor. These techniques typically include tracing information in the form of instructions and data. The resultant traced information may then be used for debugging purposes.

A trace stream contains voluminous information, which becomes unwieldy to transmit, store and debug. Consequently, there is an ongoing need for efficient ways for compressing trace streams.

### SUMMARY OF THE INVENTION

An embodiment of the invention includes a method of tracing processor instructions by invoking a trace mode and forming a compressed trace stream with a dynamic unit width indicator and a value block. The dynamic unit width indicator includes an address/data width indicator, which may be qualified by a unit indicator in a separate fixed configuration block. The value block has a width that is a function of the address/data width indicator and the unit indicator.

An embodiment of the invention includes a computer readable storage medium with executable instructions to characterize a circuit that receives a fixed unit width trace stream and forms a compressed trace stream with a dynamic unit width indicator and a value block.

An embodiment of the invention includes a processor with circuitry to form a dynamic unit width indicator and a value block. A port routes the compressed trace stream.

An embodiment of the invention includes a system with a processor to form a compressed trace stream with a dynamic unit width indicator and value block.

An embodiment of the invention includes a probe with a memory and an instruction trace control block to transform a fixed unit width trace stream to a compressed trace stream with a dynamic unit width indicator and value block.

### BRIEF DESCRIPTION OF THE FIGURES

The invention is more fully appreciated in connection with the following detailed description taken in conjunction with the accompanying drawings, in which:

FIG. 1 illustrates processing operations associated with an embodiment of the invention.

FIG. 2 illustrates a debug system configured in accordance with an embodiment of the invention.

FIG. 3 illustrates a system configured in accordance with an embodiment of the invention.

FIG. 4 illustrates a trace stream configured in accordance with an embodiment of the invention.

Like reference numerals refer to corresponding parts throughout the several views of the drawings.

### DETAILED DESCRIPTION OF THE INVENTION

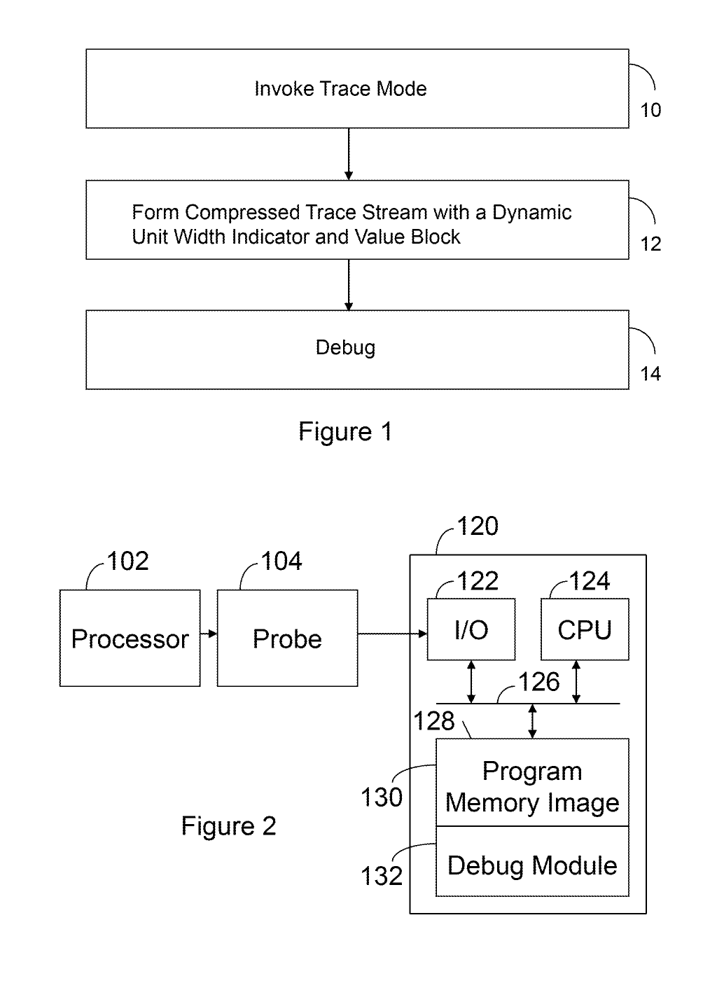

FIG. 1 illustrates processing operations associated with an embodiment of the invention. A trace mode is invoked 10. A compressed trace stream is then formed with a dynamic unit width indicator and a value block 12. Non-information bearing leading zeroes or ones in a fixed unit are eliminated. The resultant information bearing block is ascribed a dynamic unit width indicator. For example, if 32 bits of a 64 bit fixed unit have non-information bearing content, those bits are dropped and the remaining 32 bits are assigned a dynamic unit width indicator corresponding to a size of 32 bits. In this example, the remaining 32 bits form a value block.

The traced information is then debugged 14. This is typically accomplished using an image of the program executed by the processor. A debug module operating with the program image may be used to implement this operation. The debug module links the dynamic unit width indicators and unit value blocks to instructions in the program image.

FIG. 2 illustrates a system configured in accordance with an embodiment of the invention. The system includes a processor 102 to generate a compressed trace stream. A probe 104 routes the trace information to a computer 120. The probe 104 is an interface between test equipment and a device under test. In this case, the test equipment is a computer 120 and associated debug module 132 and the device under test is the processor 102. As discussed below, the probe may include circuitry to facilitate tracing operations.

Trace information from the probe 104 is routed to an input device of the computer 120. A set of input/output devices 122 may include a port to receive the trace information. The set of input/output devices 122 may also include other standard input/output devices, such as a keyboard, mouse, display, printer and the like. A central processing unit 124 is connected to the input/output devices 122 via a bus 126. A memory 128 is also connected to the bus 126. The memory 128 stores a program memory image 130 corresponding to the program being executed by the processor 102. A debug module 132 includes executable instructions to process the trace information and the program memory image 130 to perform debugging operations.

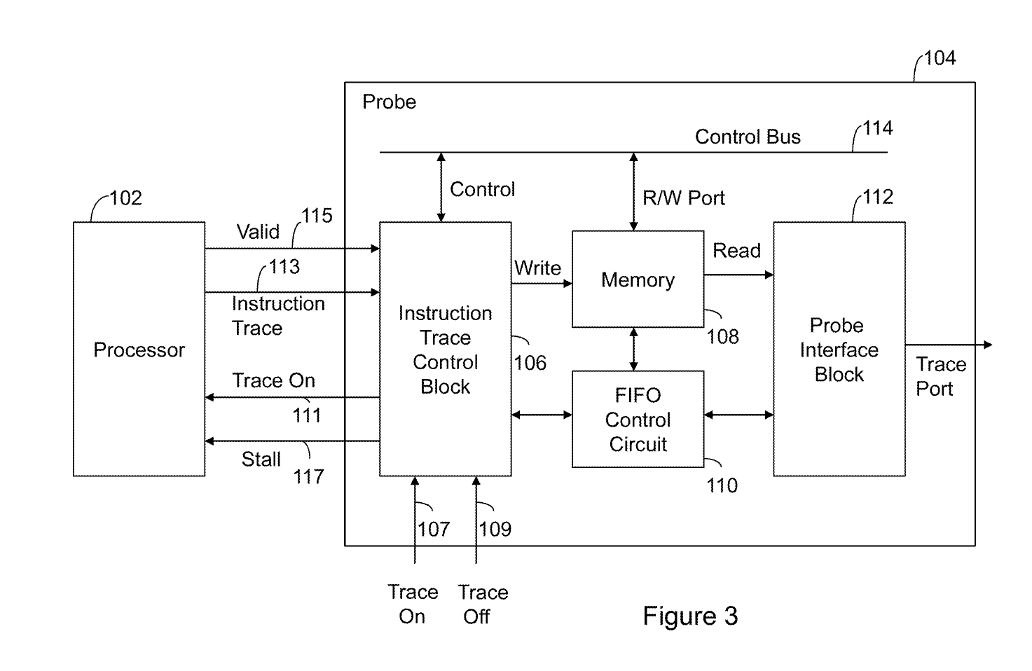

FIG. 3 is a more detailed characterization of a processor 102 and probe 104 utilized in accordance with an embodiment of the invention. The processor 102 generates a compressed trace stream on node 113. The compressed stream has a dynamic unit width indicator and value block. Alternately, the instruction trace control block 106 may receive a fixed unit width trace stream and form a compressed trace stream with a dynamic unit width indicator and value block. This allows a probe to implement operations of the invention without changing the processor core.

The instruction trace control block 106 receives a trace on command at node 107 and a trace off command at node 109. The instruction trace control block 106 routes a trace on command to the processor 102 via node 111. The instruction trace control block 106 receives an instruction trace via node 113. During cycles in which an instruction is not processed, a non-valid signal is sent from the processor 102 to the instruction trace control block 106 via node 115. This reduces the amount of trace information that needs to be processed.

The probe 104 may include a memory 108 to store the compressed trace information. Alternately, an external memory may be used in conjunction with the probe 104. In one embodiment, the memory 108 is configured as a FIFO to store traced information. The instruction trace control block 106 is configured to identify when the FIFO is close to being full and in response to this condition, generates a stall signal applied to node 117 to prevent the processor from generating additional trace information that would otherwise overflow the FIFO. A FIFO control circuit 110 is connected to the memory 108 and the instruction trace control block 106 to coordinate this operation.

An optional probe interface block 112 provides an interface between the memory 108 and an external trace port, which delivers trace information to the computer 120. The probe 104 may also include a control bus 114 to apply control signals to the instruction trace control block and to coordinate memory control.

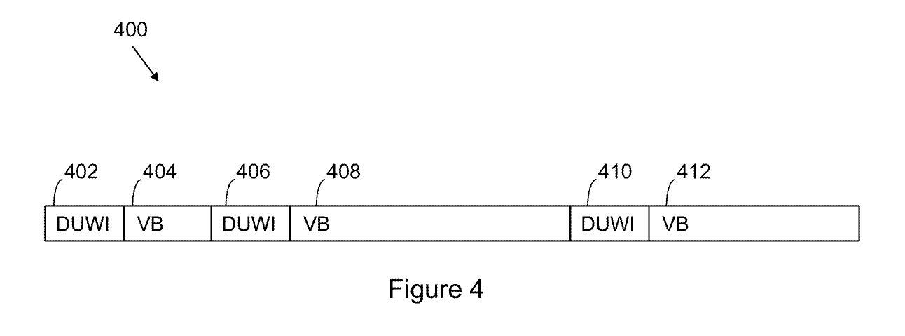

FIG. 4 illustrates a trace stream 400 produced in accordance with an embodiment of the invention. The trace stream 400 includes a first dynamic unit width indicator 402 and an associated value block 404, in this case having a size of a byte. Another dynamic unit width indicator 406 has a value block 408 with a size of a word (e.g., 4 bytes). Another dynamic unit width indicator 410 has a value block 412 with a size of a half word (e.g., 2 bytes).

The dynamic unit width indicator may be implemented in a number of ways. In one embodiment, the dynamic unit width indicator has an address/data width indicator and a unit indicator. In this embodiment, the value block has a width that is a function of the address/data width indicator and the unit indicator. For example, the address/data width indicator may be a two bit value, which may be called “ADW” for Address/Data Width. This value is combined with the unit indicator to establish the width of the value block. For example, the unit indicator may be a two bit field utilizing the following encoding: 00 for a size of byte, 01 for a size of a half word, 10 for a size of a word and 11 for a size of a double word. In this example, the width of a unit value block is the address/data width indictor ADW plus 1 multiplied by the unit size. Thus, for a byte size of 8 bits, the unit value block has a size of 8*(ADW+1). A value block for a half word has a size of 16*(ADW+1), a value block for a word has a size of 32*(ADW+1), and a value block for a double word has a size of 64*(ADW+1).

Thus, the invention provides a compressed set of information to encode a simple instruction trace from an execution stream. The simplicity of the compressed format enhances efficiency.

While various embodiments of the invention have been described above, it should be understood that they have been presented by way of example, and not limitation. It will be apparent to persons skilled in the relevant computer arts that various changes in form and detail can be made therein without departing from the scope of the invention. For example, in addition to using hardware (e.g., within or coupled to a Central Processing Unit (“CPU”), microprocessor, microcontroller, digital signal processor, processor core, System on chip (“SOC”), or any other device), implementations may also be embodied in software (e.g., computer readable code, program code, and/or instructions disposed in any form, such as source, object or machine language) disposed, for example, in a computer usable (e.g., readable) medium configured to store the software. Such software can enable, for example, the function, fabrication, modeling, simulation, description and/or testing of the apparatus and methods described herein. For example, this can be accomplished through the use of general programming languages (e.g., C, C++), hardware description languages (HDL) including Verilog HDL, VHDL, and so on, or other available programs. Such software can be disposed in any known computer usable medium such as semiconductor, magnetic disk, or optical disc (e.g., CD-ROM, DVD-ROM, etc.). The software can also be disposed as a computer data signal embodied in a computer usable (e.g., readable) transmission medium (e.g., carrier wave or any other medium including digital, optical, or analog-based medium). Embodiments of the present invention may include methods of providing the apparatus described herein by providing software describing the apparatus and subsequently transmitting the software as a computer data signal over a communication network including the Internet and intranets.

It is understood that the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

1. A method of tracing processor instructions, comprising:
invoking a trace stream mode; and
forming a compressed trace stream with a dynamic unit width indicator and a value block.

2. The method of claim 1 wherein the dynamic unit width indicator includes an address/data width indicator qualified by a unit indicator.

3. The method of claim 2 wherein the unit value block has a width that is a function of the address/data width indicator and the unit indicator.

4. The method of claim 2 wherein the unit indicator is selected from a byte unit, a half word unit, a word unit and a double word unit.

5. A computer readable storage medium storing executable instructions to characterize a circuit, comprising executable instructions to:
receive a fixed unit width trace stream; and
form a compressed trace stream with a dynamic unit width indicator and a unit value block.

6. The computer readable storage medium of claim 5 wherein the dynamic unit width indicator includes an address/data width indicator and qualified by a fixed unit indicator.

7. The computer readable storage medium of claim 6 wherein the value block has a width that is a function of the address/data width indicator and the unit indicator.

8. The computer readable storage medium of claim 6 wherein the unit indicator is selected from a byte unit, a half word unit, a word unit and a double word unit.

9. A processor, comprising:
circuitry to generate a compressed trace stream with a dynamic unit width indicator and a value block; and
a port to route the compressed trace stream.

10. The processor of claim 9 wherein the dynamic unit width indicator includes an address/data width indicator qualified by a fixed unit indicator.

11. The method of claim 10 wherein the value block has a width that is a function of the address/data width indicator and the unit indicator.

12. The method of claim 10 wherein the unit indicator is selected from a byte unit, a half word unit, a word unit and a double word unit.

13. The processor of claim 9 wherein the processor is embodied in hardware description language software.

14. The processor of claim 13 wherein the processor is embodied in one of Verilog hardware description language software and VHDL hardware description language software.

15. A system, comprising:
a processor to form a compressed trace stream with a dynamic unit width indicator and a value block; and
a probe to receive the compressed trace stream.

16. The system of claim 15 wherein the probe routes a trace on signal to the processor.

17. The system of claim 15 wherein the probe generates a stall signal for application to the processor.

18. The system of claim 15 further comprising a memory and memory control circuitry within the probe.

19. The system of claim 18 further comprising a probe interface block connected to the memory and memory control circuitry.

20. A probe, comprising:
a memory; and
an instruction trace control block to transform a fixed unit width trace stream to a compressed trace stream with a dynamic unit width indicator and value block.

21. The probe of claim 20 wherein the instruction trace control block processes a trace on signal.

22. The probe of claim 20 wherein the instruction trace control block generates a stall signal.

23. The probe of claim 20 further comprising a memory and memory control circuit connected to the instruction trace control block.
